(19) United States
(12) Patent Application Publication
(10) Pub. No.: US 2005/0087567 A1
(43) Pub. Date: Apr. 28, 2005

(54) Dispensing device

(75) Inventors: Keld Krogh Nielsen, Grasten (DK); Svend Erik Lund Nielsen, Krusa (DK)

Correspondence Address: KLEIN, O'NEILL & SINGH, 2 PARK PLAZA, SUITE 510, IRVINE, CA, 92614, US

(73) Assignee: NIELSEN TEXTIL A/S, Krusa (DK)

(21) Appl. No.: 10/938,763

(22) Filed: Sep. 10, 2004

Related U.S. Application Data
(63) Continuation of application No. PCT/DK03/00160, filed on Mar. 13, 2003.

(30) Foreign Application Priority Data
Mar. 13, 2002 (DK) PA 2002 00382

(51) Int. Cl. G01F 11/10

(52) U.S. Cl. 222/361

(57) ABSTRACT

A device for batch dispensing granular material such as instant coffee and comprising a bottom portion (62) adapted for being screwed unto the neck of a container of granular material and a top portion (63) fixedly attached to the bottom portion with a disc portion (61) rotatably arranged therebetween, the bottom portion having a plate portion (64) with an aperture for allowing granular material to flow from said container into a passage (72) in said disc portion (61) when said disc portion (61) is in a first rotational position, and the top portion (63) having a plate portion (65) with an aperture for allowing granular material in said passage (72) to be dispensed to for instance a cup for preparing instant coffee when said disc portion (61) is in a second rotational position.

The present invention relates to a combination of a dispensing device for batch dispensing granular material such as ground coffee, freeze-dried instant coffee or tea, sugar, detergent powder and the like and a hand-held container for the granular product having a top portion and a bottom portion.

Many combinations of a storage container and a dispensing device are known in the art, but all such known combinations are complicated as regards use and/or constructive elements.

In connection with dispensing of instant coffee powder, ground coffee, detergent powder and the like, the normal procedure is to open a container thereof and remove a batch either with a spoon or by pouring. This is an imprecise and often messy procedure. Furthermore, the repeated opening of the storage container in connection with each dispensing operation gives rise to deterioration of those granular products that lose aroma or are oxidized by contact with the oxygen in the atmosphere.

Therefore, there is a need for a simple and inexpensive combination of a storage container and a dispensing device for granular product that may be operated by any person and protects the contents of the container against deterioration by loss of aroma or oxidation by limiting the contact with the atmosphere. The batchwise dispensing should also be relatively precise and uniform so that it is ensured that the desired total amount of product dispensed is achieved without having to resort to further measuring actions.

According to the invention, the above objectives are obtained by said container being manually rotatable from an upright position with said top portion located above said bottom portion and an inverted position with said top portion located below said bottom portion, the device and container comprising cooperating attachment means for allowing integral or releasable attachment of the device at or adjacent said top portion of said container, the device further comprising a body having or together with said container defining a passage extending in a material flow direction from a material inlet for allowing granular material to enter said passage from said container to a material outlet for allowing granular material to exit from said passage, an overflow or barrier chamber being defined in said passage between said material inlet and said material outlet by means of an inlet barrier wall and an outlet barrier wall extending transversely to said material flow direction, said inlet barrier wall defining an inlet barrier aperture configured and located so as to allow material to flow into said barrier chamber in said flow direction when said container is in said inverted position and to hinder said material in flowing out of said barrier chamber opposite said flow direction when said container is in said upright position, and said outlet barrier wall defining an outlet barrier aperture configured and located so as to allow material to flow out of said barrier chamber in said flow direction when said container is in said upright position and to hinder said material in flowing out of said barrier chamber in said flow direction when said container is in said inverted position.

Hereby, an intuitively easily understandable and easily implementable pouring motion will entail dispensing of relatively uniformly sized batches of the granular material without having to access the interior of the container and without any substantial risk of spilling material.

In the currently preferred embodiment of a combination according to the invention, said passage extends in said material flow direction between and along two opposed side walls, a top wall and a bottom wall past said inlet and outlet barrier wall extending transversely to said flow direction from one side wall to the other side wall, said inlet barrier wall extending from said bottom wall part way across said passage towards said top wall such that said inlet barrier aperture is defined between the free edge of said inlet barrier wall and said top wall, and said outlet barrier wall extending from said top wall part way across said passage towards said bottom wall such that said outlet barrier aperture is defined between the free edge of said outlet barrier wall and said bottom wall.

According to the invention, the said attachment means are adapted for hermetically sealing the interface between said container and said dispensing device. Hereby, it is ensured that no atmospheric air containing moisture may enter into the container past this interface.

In one embodiment of a combination according to the invention, a closure means is provided for closing said material outlet and said closure means is provided with sealing means for cooperating with corresponding sealing means of said material outlet for hermetically sealing said material outlet. Hereby, it is further ensured that no atmospheric air containing moisture may enter into the container past this closure and no aroma is lost when dispensing is not taking place and the aperture is closed.

Preferably, said material outlet has an oval or elliptical shape, and said closure means is a lid hingedly connected to said dispensing device.

Advantageously, said container is a standard jar having a circular cylindrical neck portion provided with screw threads, and said body has a circular cylindrical body portion matching said neck portion and provided with engagement means for engaging said screw threads for screwing said device on to said neck portion, and a sealing gasket is provided between said neck portion and said body portion.

In one embodiment, said bottom wall is constituted by a separate plate of resilient material such as plastic foam abutting an annular shoulder of said body portion along the periphery of said plate such that said periphery is clamped between the rim of said neck portion and said shoulder when the dispensing device is screwed on said neck portion. Hereby the manufacture of the dispensing device is faciitated in manner also having the advantage of providing an efficient hermetical seal between the device and the container.

In a second embodiment of a combination according to the invention, said container is a box of cardboard, rigid plastic plate material or the like, and said dispensing device is made of cardboard, rigid plastic plate material or the like.

Preferably, said box is provided with a recess cut out of the walls thereof at said top portion and adapted for receiving said dispensing device.

The present invention furthermore relates to a dispensing device for batch dispensing granular material such as ground coffee, freeze-dried instant coffee, sugar, detergent powder and the like from a hand-held container and comprising a body having a passage extending in a material flow direction from a material inlet opening to a material outlet opening and between and along two side walls, a top wall and a bottom wall past a first and a second transverse wall extending transversely to said flow direction from one side wall to the other side wall, said first transverse wall having a material inlet aperture located closer to said top wall than to said bottom wall and said second transverse wall having a material outlet aperture located closer to said bottom wall than to said top wall.

In the currently preferred embodiment of a dispensing device according to the invention, said first transverse wall extends from said bottom wall part way across said passage towards said top wall such that said material inlet aperture is defined between the free edge of said first transverse wall and said top wall, and said second transverse wall extending from said top wall part way across said passage towards said bottom wall such that said material outlet aperture is defined between the free edge of said second transverse wall and said bottom wall.

Preferably, a closure means is provided for closing said material outlet opening, and said closure means is provided with sealing means for cooperating with corresponding sealing means of said material outlet for hermetically sealing said material outlet opening.

Advantageously, said material outlet opening has an oval or elliptical shape, and said closure means is a lid hingedly connected to said dispensing device.

Preferably, said lid on one surface thereof is provided with a resilient sealing gasket for sealingly engaging the edge of said material outlet opening.

In one embodiment of a dispensing device according to the invention, said bottom wall is provided with said material inlet opening and said top wall is provided with said material inlet opening aperture.

Advantageously, said top wall is constituted by a separate plate of resilient material such as plastic foam abutting a shoulder of said body along the periphery of said plate.

In connection with containers suited for attaching the dispensing device to the inner surface of the wall of the container, said top wall may be removed such that the resulting free edges of said two side walls and said second transverse wall may be attached to said interior surface of a wall of a container.

In the following, the invention will be explained more in detail in connection with different embodiments of the combination and the dispensing device according to the invention shown, solely by way of example, in the accompanying drawings where

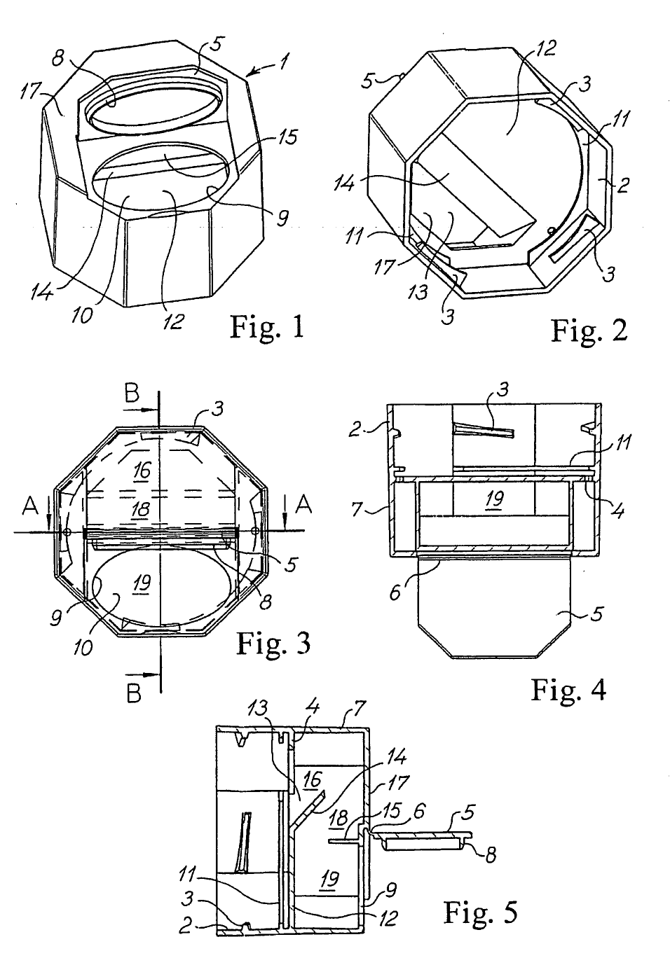

FIG. 1 is a schematic top perspective view of a first embodiment of a dispensing device according to the invention,

FIG. 2 is a schematic bottom perspective view of the device in FIG. 1,

FIG. 3 is a schematic top view of the device in FIG. 1,

FIGS. 4 and 5 are schematic sectional views of the device in FIG. 3 taken along lines A-A and B-B, respectively,

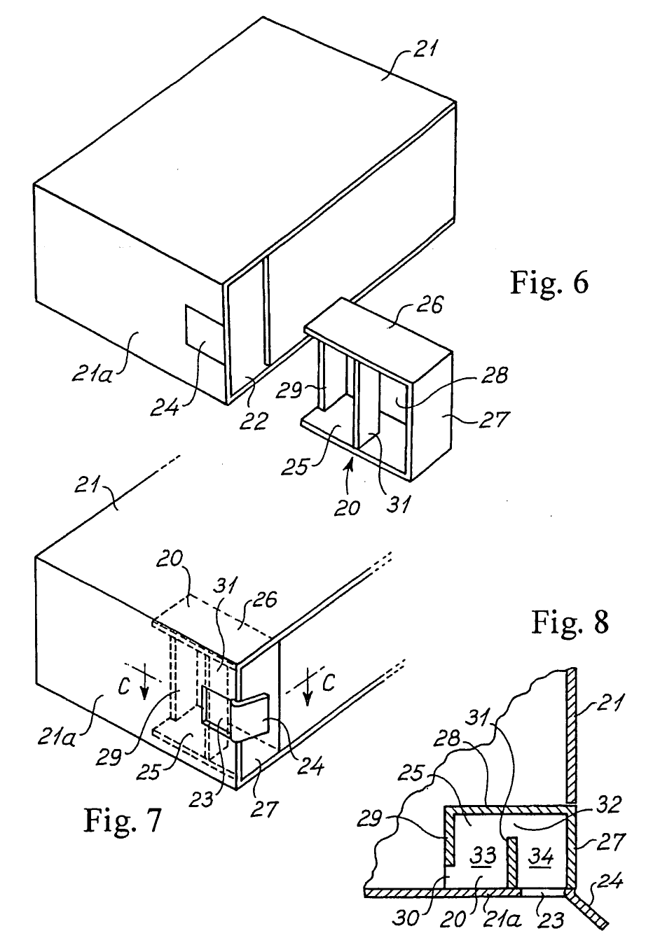

FIG. 6 is a schematic perspective view of a box shaped container and a second embodiment of a dispensing device according to the invention for use with the container,

FIG. 7 is a cut-away view corresponding to FIG. 6 with the dispensing device assembled with the container,

FIG. 8 is an enlarged scale cut-away sectional view taken along line C-C in FIG. 7,

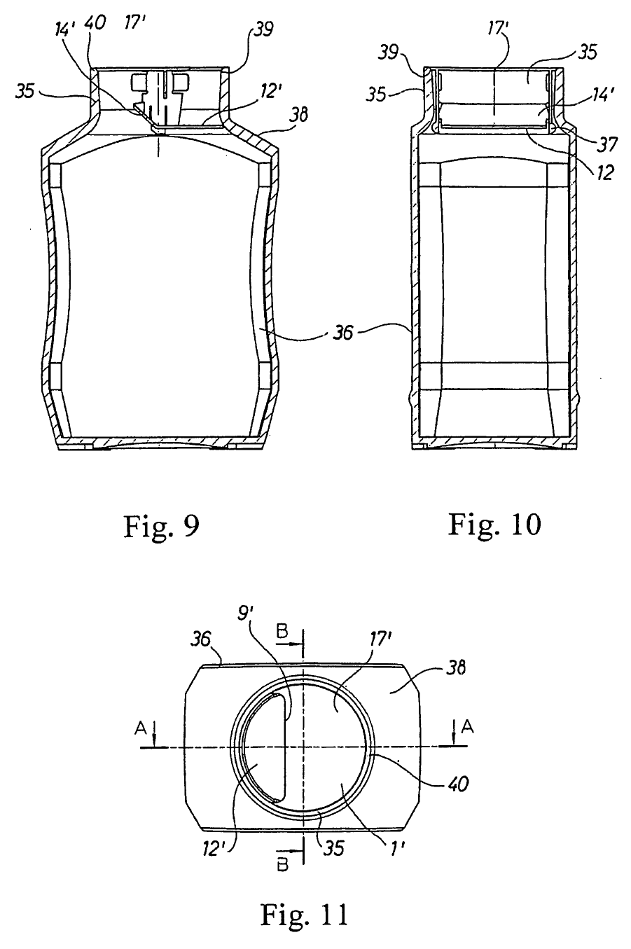

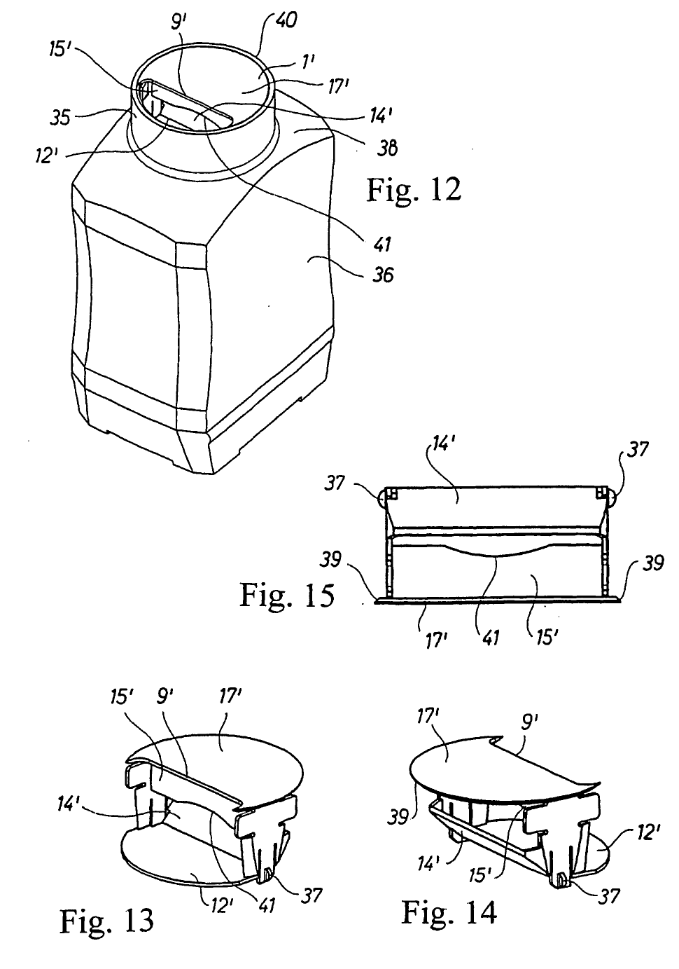

FIGS. 9-12 are two schematic cross sectional views, a schematic top view and a schematic perspective view, respectively, of a currently preferred combination of a container and dispensing device according to the invention, the cross sectional views of FIGS. 9 and 10 being taken along lines A-A and B-B, respectively, in FIG. 11, and

FIGS. 13-14 are schematic perspective views seen in mutually substantially opposite directions of a dispensing device according to the invention suitable for, inter alia, being incorporated in the combination shown in FIGS. 9-12,

FIG. 15 is a schematic frontal, elevation view of the dispensing device of FIGS. 13-14,

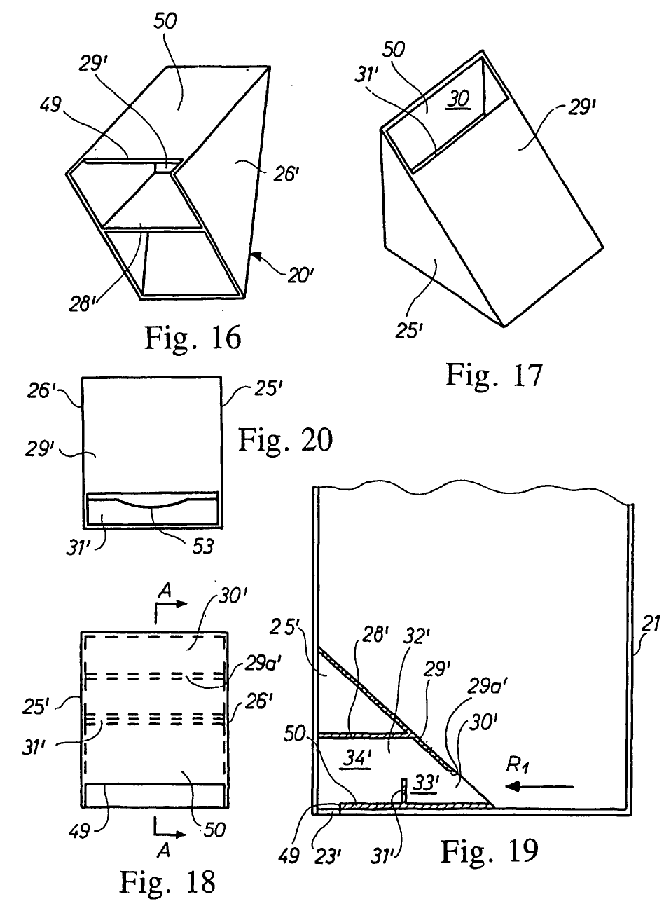

FIGS. 16-17 are schematic perspective views seen in mutually substantially opposite directions of a dispensing device according to the invention suitable for, inter alia, being incorporated in the combination shown in FIG. 19,

FIG. 18 is a schematic top view of the device in FIGS. 16-17 viewed towards the uppermost wall of the device in FIG. 16,

FIG. 19 is schematic, broken away, partly sectional view of a combination of a box and the device of FIGS. 16-18, and

FIG. 20 is a schematic frontal, elevation view of the device of FIGS. 16-19 seen in the direction of arrow R1.

Referring now to FIGS. 1-5, a dispensing device 1 intended for being screwed on to the neck of a not shown jar containing granular material such as, for Instance, instant coffee or instant tea, has a bottom portion 2 for receiving said neck with projections 3 engaging a screw thread on the outer surface of said neck such that the dispensing device 1 functions as a closure of the jar by obstructing the open mouth thereof.

A lid 5 pivotably connected by a hinge 6 to a top portion 7 of the device 1 is provided with a resilient oval sealing gasket or ridge 8 for sealingly engaging an edge or rim 9 of an oval dispensing aperture 10 such that the gasket 8 totally prevents air from entering the jar when the lid 5 closes the aperture 10.

An annular sealing shoulder 4 is provided for abutment of an annular sealing gasket (not shown) to be pressed between said shoulder 4 and the rim of the jar mouth so as to seal the jar mouth from the surrounding atmosphere in a well known manner. An interrupted annular shoulder 11 is provided to retain the annular gasket in place between shoulder 11 and shoulder 4.

The annular sealing shoulder 4 forms part of a bottom wall 12 dividing the device 1 into bottom portion 2 and top portion 7. An aperture 13 in said bottom wall 12 communicates the interior of the bottom portion 2 and thereby the interior of the jar with the interior of the top portion 7.

A sloping inlet barrier wall 14 extends from the bottom wall 12 into the interior of top portion 7 and defines an inlet chamber 16 between the wall 14 and the outer wall of the top portion 7. An outlet barrier wall 15 projects into the interior of the top portion 7 from the top wall 17 of the device 1 and together with inlet barrier wall 14 defines a barrier or overflow chamber 18, and outlet barrier wall 15 defines an outlet chamber 19 together with exterior wall of top portion 7.

An inlet barrier aperture between inlet chamber 16 and barrier chamber 18 is defined between the free edge of the inlet barrier wall 14 and the top wall 17, and an outlet barrier aperture between barrier chamber 18 and outlet chamber 19 is defined between the free edge of outlet barrier wall 15 and the bottom wall 12.

In use, when dispensing granular material from the interior of the jar, the jar is inverted so that the mouth of the jar and the top wall 17 of the device 1 face generally downwards. In this inverted position of the jar, granular material will flow through the aperture 13 into the chamber 16 and further into the barrier chamber 18 via said inlet barrier aperture until being stopped by the outlet barrier wall 15.

The jar is then rotated so that the mouth of the jar and the top wall 17 are facing generally upwards. Hereby, part of the granular material in the chamber 16 will flow back through the aperture 13 into the jar and the other part will be prevented from doing so by inlet barrier wall 14 and this other part will flow into the barrier chamber 18 and the outlet chamber 19.

When the jar thereafter is inverted once again, most of the material in chamber 18 and practically all the material in chamber 19 flows out through the dispensing aperture 10 while a new portion of material enters chamber 16 and overflows into chamber 18 through said inlet aperture.

The granular material in the jar will thus be dispensed in substantially uniform portions for each time the jar is returned to a generally upright position and thereafter inverted to a generally upside down position.

Some granular materials such as instant coffee are hygroscopic and therefore such granular material in the jar should be prevented from contact with the surrounding atmospheric air containing moisture whenever dispensing is not taking place.

It is therefore important that the sealing gaskets between the dispensing device 1 and the jar and between the lid 5 and the dispensing aperture edge 9 are hermetically tight when the dispensing device 1 is screwed tightly on the neck of the jar and the lid 5 closes the dispensing aperture 10 with the gasket 8 sealingly engaging the aperture edge 9.

For manufacturing reasons, the bottom wall 12 with the aperture 13 and the sloping wall 14 may be configured as a separate element. Said element may be made of a resilient foam-like plastic material such that the wall 12 may be inserted against a not shown internal annular shoulder of the device such that the circumferential edge or periphery of the wall 12 may function as a sealing gasket between the jar mouth rim and the dispensing device 1.

Referring now to FIGS. 6-8, there is shown a dispensing device 20 for use for dispensing granular material such as detergent powder or an antibiotic in powder form from a box 21 of cardboard, plastic or the like.

The box 21 is provided with an aperture 22 for receiving the dispensing device as shown in FIG. 7. The dispensing device 20 may alternatively be built into the box 21 during the manufacturing process of the box. A dispensing outlet 23 with a closure lid or flap 24 therefore is provided at a corner edge of the box 21.

The dispensing means 20 is provided with side walls 25 and 26, an end wall 27 and a bottom wall 28. An inlet barrier wall 29 defines an inlet barrier opening 30 for communicating the interior of the device 20 with the interior of the box 21 when the dispensing device 20 is inserted in the box 21 as shown in FIGS. 7 and B. An outlet barrier wall 31 is attached to the side walls 25 and 26 and defines an outlet barrier aperture 32 between a barrier chamber 33 and an outlet chamber 34. The dispensing aperture 23 communicates the outlet chamber 34 with the exterior surroundings of the box 21, and the barrier chamber 33 communicates with the interior of the box 21 and with the outlet chamber 34.

In use, when dispensing granular material from the interior of the box 21, the box 21 is inverted so that the outlet aperture 23 of the box faces downwards. In this inverted position of the box, granular material will flow through the inlet barrier aperture 30 defined between the free edge of the inlet barrier wall 29 and the top wall 21a of the box 21 and into the barrier chamber 33 until being stopped by the outlet barrier wall 31.

The box 21 is then rotated so that the outlet aperture 23 and the top wall 21a are facing upwards. Hereby, the granular material in the chamber 33 will flow through the outlet barrier aperture 32 defined between the free edge of the outlet barrier wall 31 and the bottom wall 28 and into the outlet chamber 34.

When the box 21 thereafter is inverted once again, practically all the material in chamber 34 and some of the material in chamber 33 flows out through the dispensing aperture 23 while a new portion of material enters barrier chamber 33 through inlet barrier aperture 30.

The granular material in the box 21 will thus be dispensed in substantially uniform portions for each time the box is returned to a generally upright position and thereafter inverted.

The dispensing device 20 may be made of cardboard or of any other suitable plate or sheet material such as a plastic material and the like. The closure of the dispensing opening 23 may be carried out in a hermetically sealed manner, for instance as described in connection with the embodiment of FIGS. 1-5.

The device 20 may have a top wall covering chambers 33 and 34 (instead of wall 21a of the box) such that the device may entirely replace a top corner of the box 21 instead of being inserted in an aperture as in FIG. 6.

A device similar to the device in FIGS. 1-5 may be attached to the box 21 either exteriorly or interiorly.

The box 21 may be substituted by a flexible bag of flexible sheet material or a rigid jar or bottle of stiff material such as glass or metal.

Referring now to FIGS. 9-14, a dispensing device 1′ according to the invention very similar to the dispensing device 1 in FIGS. 1-5 is adapted for being inserted inside the neck 35 of a container 36 for storing and dispensing of, for instance, particles of freeze-dried coffee or freeze-dried tea. Thus, by placing the dispensing device 1′ inside the neck 35 of said container 36 a currently preferred combination of a container with a neck and a dispensing device according to the invention is provided where a normal closure cap can ensure isolation of the particles from the atmosphere when no dispensing of granular material is taking place. The closure cap (not shown) may be screwed on to not shown external threads on the neck 35 or it may fit tightly and resiliently over the neck 35.

The dispensing device 1′ is held removably in place inside the neck 35 by knobs or projections 37 that are dimensioned and located to engage the top portion of the shoulder 38 of the container or jar 36 (see FIG. 10) while an oblique edge 39 of bottom wall 12′ rests on the rim 40 of the neck such that the top surface of the top wall 17′ of the device is flush with or slightly below the rim 40 such that a not shown metal foil may be adhered to the rim for protecting the contents of the jar from contact with the atmosphere during storage of the jar prior to being opened for dispensing the first dose of material from the jar 35 in a manner well known in this type of container.

The device 1′ may alternatively be made of a resilient material with good friction properties relative to the interior surface of the neck 35. If the neck 35 is of glass the material of the device 1′ may be a mixture of approx. 80% PP and approx. 20% SEBS. In such case the knobs 37 may be eliminated. This frictional engagement between the device 1′ and the inner surface of the neck 35 allows the 70p wall to be placed 1-2 mm below the rim 40 without having the oblique edge 39.

A sloping inlet barrier wall 14′ extends from the bottom wall 12′, and an inlet chamber is defined between the walls 14′ and the inner surface of the neck 35. An outlet barrier wall 15′ projects from the top wall 17′ of the device 1′ and together with inlet barrier wall 14′ defines a barrier or overflow chamber, and outlet barrier wall 15′ and bottom wall 12′ define an outlet chamber together with interior surface of the neck 35.

An inlet barrier aperture between the inlet chamber and the barrier chamber is defined between the free edge of the inlet barrier wall 14′ and the top wall 17′, and an outlet barrier aperture between the barrier chamber and the outlet chamber is defined between the free edge of outlet barrier wall 15′ and the bottom wall 12′.

The free edge of the outlet barrier wall 15′ is provided with a shallow indentation, depression or recess 41 increasing the size of the outlet barrier aperture in the region of the indentation 41.

In use, when dispensing granular material from the interior of the jar 36, the jar is inverted so that the mouth of the jar and the top wall 17′ of the device 1′ face generally downwards. In this inverted position of the jar, granular material will flow into the inlet chamber and further into the barrier chamber via said inlet barrier aperture until being stopped by the outlet barrier wall 15′.

The jar 36 is then rotated so that the mouth of the jar and the top wall 17′ are facing generally upwards. Hereby, part of the granular material in the inlet chamber will flow back through the inlet aperture into the jar, and the other part will be prevented from doing so by inlet barrier wall 14′. This other part will flow into the barrier chamber and the outlet chamber.

When the jar 36 thereafter is inverted once again, most of the material in the barrier chamber and practically all the material in the outlet chamber will flow out through the dispensing aperture 9′ while a new portion of material enters the inlet chamber and overflows into the barrier chamber through said inlet aperture.

The granular material in the jar 36 will thus be dispensed in substantially uniform portions for each time the jar is returned to a generally upright position and thereafter inverted to a generally upside down position.

The horizontal axis around which the jar 36 is inverted and righted should be generally parallel to the plane of the outlet barrier wall 15′.

If an additional portion of granular material smaller than a full portion is desired, the jar 36 may be held in a halfway inverted position and rotated 45 degrees around a vertical axis with respect to the usual inverting orientation whereby granulate material may flow past the outlet barrier wall 15′ through the indentation 41.

Referring now to FIGS. 16-20, the dispensing device 20′ is very similar to the dispensing device of FIGS. 6-8 and is designed for being arranged at a corner of a box 21′ having a dispensing aperture 23′.

The dispensing device 20′ is provided with side walls 25′ and 26′, a bottom wall 28′ and a top wall 50. An inlet barrier wall 29′ defines an inlet barrier opening 30′ for communicating the interior of the device 20′ with the interior of the box 21′ when the dispensing device 20′ is inserted in the box 21′ as shown in FIG. 19. An outlet barrier wall 31′ is attached to the side walls 25 and 26 and defines an outlet barrier aperture 32′ between a barrier chamber 33′ and an outlet chamber 34′. The dispensing aperture 23′ communicates the outlet chamber 34′ with the exterior surroundings, and the barrier chamber 33′ communicates with the interior of the box 21′ and with the outlet chamber 34′.

In use, when dispensing granular material from the interior of the box 21′, the box 21′ is inverted so that the outlet aperture 23′ of the box faces downwards. In this inverted position of the box, granular material will flow through the inlet barrier aperture 30′ defined between the free edge 29a′ of the inlet barrier wall 29′ and the wall 50 and into the barrier chamber 33′ until being stopped by the outlet barrier wall 31′.

The box 21′ is then rotated so that the outlet aperture 23′ and the top wall 50 are facing upwards. Hereby, some of the granular material in the chamber 33′ will flow through the outlet barrier aperture 32′ defined between the free edge of the outlet barrier wall 31′ and the bottom wall 28′ and into the outlet chamber 34′.

When the box 21′ thereafter is inverted once again, practically all the material in chamber 34′ and some of the material in chamber 33′ flows out through the dispensing aperture 23′ while a new portion of material enters barrier chamber 33′ through inlet barrier aperture 30′.

The granular material in the box 21′ will thus be dispensed in substantially uniform portions for each time the box is returned to a generally upright position and thereafter inverted.

The free edge of the outlet barrier wall 31′ is provided with a shallow indentation, depression or recess 53 increasing the size of the outlet barrier aperture in the region of the indentation 53 in a manner very similar to indentation 41 in FIG. 15.

If an additional portion of granular material smaller than a full portion is desired, the jar box 21′ may be held in a halfway inverted position and rotated 45 degrees around a vertical axis with respect to the usual inverting orientation whereby granulate material may flow past the outlet barrier wall 15′ through the indentation 53.

The dispensing devices 20 and 20′ may be made of cardboard or of any other suitable plate or sheet material such as a plastic material and the like. The closure of the dispensing openings 23 and 23′, respectively may be carried out in a hermetically sealed manner, for instance as described in connection with the embodiment of FIGS. 1-5.

In the foregoing top and bottom portions of the containers have been used for reference indicating that the container is to be inverted and righted with the top portion below and above, respectively, the bottom portion. It should be understood that top portion and bottom portion may indicate portions of the container relatively remote from each other and not necessarily portions which are top and bottom when the container is in its natural or normal storage position.

1. A combination of a dispensing device for batch dispensing granular material such as ground coffee, freeze-dried instant coffee or tea, sugar, detergent powder and the like and a hand-held container for the granular product having a top portion and a bottom portion, said container being manually rotatable from an upright position with said top portion located above said bottom portion and an inverted position with said top portion located below said bottom portion, the device and container comprising cooperating attachment means for allowing integral or releasable attachment of the device at or adjacent said top portion of said container, the device further comprising a body having or together with said container defining a passage extending in a material flow direction from a material inlet for allowing granular material to enter said passage from said container to a material outlet for allowing granular material to exit from said passage, an overflow or barrier chamber being defined in said passage between said material inlet and said material outlet by means of an inlet barrier wall and an outlet barrier wall extending transversely to said material flow direction, said inlet barrier wall defining an inlet barrier aperture configured and located so as to allow material to flow into said barrier chamber in said flow direction when said container is in said inverted position and to hinder said material in flowing out of said barrier chamber opposite said flow direction when said container is in said upright position, and said outlet barrier wall defining an outlet barrier aperture configured and located so as to allow material to flow out of said barrier chamber in said flow direction when said container is in said upright position and to hinder said material in flowing out of said barrier chamber in said flow direction when said container is in said inverted position.

2. A combination according to claim 1, wherein said passage extends in said material flow direction between and along two opposed side walls, a top wall and a bottom wall past said inlet and outlet barrier wall extending transversely to said flow direction from one side wall to the other side wall, said inlet barrier wall extending from said bottom wall part way across said passage towards said top wall such that said inlet barrier aperture is defined between the free edge of said inlet barrier wall and said top wall, and said outlet barrier wall extending from said top wall part way across said passage towards said bottom wall such that said outlet barrier aperture is defined between the free edge of said outlet barrier wall and said bottom wall.

3. A combination according to claim 2, wherein said free edge of said outer barrier wall is provided with an indentation.

4. A combination according to claim 1, wherein the said attachment means are adapted for hermetically sealing the interface between said container and said dispensing device.

5. A combination according to claim 1, wherein a closure means is provided for closing said material outlet.

6. A combination according to claim 5, wherein said closure means is provided with sealing means for cooperating with corresponding sealing means of said material outlet for hermetically sealing said material outlet.

7. A combination according to claim 1, wherein said material outlet has an oval or elliptical shape.

8. A combination according to claim 5, wherein said closure means is a lid hingedly connected to said dispensing device.

9. A combination according to claim 1, wherein said container is a standard jar having a circular cylindrical neck portion provided with screw threads, and said body has a circular cylindrical body portion matching said neck portion and provided with engagement means for engaging said screw threads for screwing said device on to said neck portion.

10. A combination according to claim 9, wherein a sealing gasket is provided between said neck portion and said body portion.

11. A combination according to claim 9, wherein said bottom wall is constituted by a separate plate of resilient material such as plastic foam abutting an annular shoulder of said body portion along the periphery of said plate such that said periphery is clamped between the rim of said neck portion and said shoulder when the dispensing device is screwed on said neck portion.

12. A combination according to claim 1, wherein said container is a standard jar having a neck portion with a mouth, and said body has a shape matching the interior surface of said neck portion such that said body may be inserted inside said neck portion through said mouth.

13. A combination according to claim 12, wherein said body is provided with fixating means for fixating said body inside said neck portion.

14. A combination according to claim 13, wherein the material of said body is chosen such relative to the material of said neck portion that fixation of said body portion inside said neck portion is achieved by friction between said body and said neck portion.

15. A combination according to claim 14, wherein said neck portion is of glass and the material of said body consists of approx. 80% PIP and approx. 20% SEBS.

16. A combination according to claim 1, wherein said mouth is covered by a sheet of foil adhered to the rim of said mouth.

17. A combination according to claim 1, wherein said container is a box made of cardboard, rigid plastic plate material or the like.

18. A combination according to claim 17, wherein said dispensing device is made of cardboard.

19. A combination according to claim 17, wherein said dispensing device is made of a rigid plastic plate material or the like.

20. A combination according to claim 17, wherein said box is provided with a recess cut out of the walls thereof at said top portion and adapted for receiving said dispensing device.

21. A dispensing device for batch dispensing granular material such as ground coffee, freeze-dried instant coffee, sugar, detergent powder and the like from a hand-held container and comprising a body having a passage extending in a material flow direction from a material inlet opening to a material outlet opening and between and along two side wails, a top wall and a bottom wall past a first and a second transverse wall extending transversely to said flow direction from one side wall to the other side wall, said first transverse wall having a material inlet aperture located closer to said top wall than to said bottom wall and said second transverse wall having a material outlet aperture located closer to said bottom wall than to said top wall.

22. A dispensing device according to claim 21, wherein said first transverse wall extends from said bottom wall part way across said passage towards said top wall such that said material inlet aperture is defined between the free edge of said first transverse wall and said top wall, and said second transverse wall extending from said top wall part way across said passage towards said bottom wall such that said material outlet aperture is defined between the free edge of said second transverse wall and said bottom wall.

23. A dispensing device according to claim 22, wherein free edge of said second transverse wall is provided with an indentation.

24. A dispensing device according to claim 21, wherein a closure means is provided for closing said material outlet opening.

25. A dispensing device according to claim 24, wherein said closure means is provided with sealing means for cooperating with corresponding sealing means of said material outlet for hermetically sealing said material outlet opening.

26. A dispensing device according to claim 21, wherein said material outlet opening has an oval or elliptical shape.

27. A dispensing device according to claim 24, wherein said closure means is a lid hingedly connected to said dispensing device.

28. A dispensing device according to claim 27, wherein said lid on one surface thereof is provided with a resilient sealing gasket for sealingly engaging the edge of said material outlet opening.

29. A dispensing device according to claim 21, wherein said bottom wall is provided with said material inlet opening.

30. A dispensing device according to claim 21, wherein said top wall is provided with said material inlet opening aperture.

31. A dispensing device according claim 21, wherein said top wall is constituted by a separate plate of resilient material such as plastic foam abutting a shoulder of said body along the periphery of said plate.

32. A dispensing device according to claim 21, wherein said top wall is removed such that the resulting free edges of said two side walls and said second transverse wall may be attached to the interior surface of a wall of a container.

33. A dispensing device according to claim 21, wherein the material of said body consists of approx. 80% PP and approx. 20% SEBS.

34. A combination of a dispensing device according to claim 21 and a hand-held container for said granular product having a top portion and a bottom portion, said container being manually rotatable from an upright position with said top portion located above said bottom portion and an inverted position with said top portion located below said bottom portion, the device and container comprising cooperating attachment means for allowing integral or releasable attachment of the device at or adjacent said top portion of said container.
